(19) United States
(12) Patent Application Publication
(10) Pub. No.: US 2020/0087082 A1
(43) Pub. Date: Mar. 19, 2020

(54) Conveyor Mechanism with a Suction Cup, an End Effector and a Robot

(71) Applicant: Shenzhen Dorabot Inc., Shenzhen (CN)

(72) Inventor: Wolf Schaarschmidt, Shenzhen (CN)

(21) Appl. No.: 16/669,509

(22) Filed: Oct. 30, 2019

Related U.S. Application Data
(63) Continuation-in-part of application No. PCT/CN2019/097507, filed on Jul. 24, 2019.

(30) Foreign Application Priority Data
Jul. 24, 2018 (CN) 201821182086.4

(51) Int. Cl. B65G 47/52; B65G 13/02; B65G 39/18; B65G 15/28; B65G 47/91; B65G 47/92; B25J 15/00; B25J 15/06

(52) U.S. Cl. CPC B65G 47/52; B65G 13/02; B65G 39/18; B65G 15/28; B65G 2207/14; B65G 47/92; B25J 15/0085; B25J 15/06; B65G 47/91

(57) ABSTRACT

The invention provides a conveyor mechanism with a suction cup, an end effector and a robot, and the conveyor mechanism can receive the cargo transported from a external conveying mechanism, and the suction cup can suck the cargo, so that the cargo is firmly placed on the conveyor mechanism to prevent it from falling, which increases the reliability of the robot to grasp the cargo, and also increases the upper limit of the moving speed of the robot arm while ensuring that the cargo does not fall down from the end effector, and meanwhile increases the success rate and processing speed of the logistics transportation.

### RELATED APPLICATION

This application is a Continuation-In-Part of International Application No. PCT/CN2019/097507 filed on Jul. 24, 2019, which is based upon and claims priority to Chinese Patent Application No. 201821182086.4, filed on Jul. 24, 2018, the entire contents of which are incorporated herein by reference.

### FIELD OF THE INVENTION

The invention relates generally to the field of cargo conveying, and in particular to a conveyor mechanism with a suction cup, an end effector and a robot.

### BACKGROUND OF THE INVENTION

The robot is a kind of machine that can automatically perform work. It is widely used in various fields such as industry and construction industry, and the logistics and transportation industry also has a large number of cases of applying robots to perform work. For example, when transporting luggage at an airport, robots can be used for automatically moving and transporting the luggage.

At present, the robot of transporting cargo obtains the cargo by an end effector of the robot after the cargo is transported by an external conveyor. After that, the robot carries the cargo to a sorting centre or a specific container by moving the robot arm, but during the robot arm moving, there is a risk that the end effector would drop the cargo because of the end effector lack of a corresponding structure to firmly grasp the cargo, and meanwhile the moving speed of the robot arm is limit to avoid the possibility of dropping the cargo.

### SUMMARY OF THE INVENTION

The purpose of this invention is that in order to overcome at least one of the problems of the prior art described above, and increase the reliability and processing speed of the robot to grasp the goods, the present invention provides the following technical solutions.

In accordance with an aspect of the invention, a conveyor mechanism equipped with a suction cup, comprising: a transport portion, for receiving cargo; a backplane mounted at one end of the transport portion; at least one suction cup mounted at the backplane, facing the direction in which the cargo comes in.

Preferably, the transport portion comprises: a track frame connected with the backplane, and a plurality of rolling portions arranged on the track frame.

Preferably, each rolling portion comprises: a rotating shaft, of which two opposite ends are connected with the track frame, and a rolling cylinder sleeved on the rotating shaft or a rolling wheel sleeved on the rotating shaft.

Preferably, the transport portion further includes a conveyor belt sleeved on at least two rolling portions of the plurality of rolling portions.

Preferably, the conveyor mechanism further includes a motor driving device that drives all or part of the rolling portions to rotate.

Preferably, at least one rib is connected between the outer frames of the track frame.

Preferably, the at least one suction cup comprises one or more of the following: an electrostatic suction cup, a vacuum suction cup, an electromagnetic suction cup.

In accordance with another aspect of the invention, an end effector, comprising: a transport portion, for receiving cargo; and the transport portion including: a track frame, and a plurality of rolling portions arranged on the track frame; and the transport portion having a conveyor belt that is driven to move over the stationary rolling portions so as the end effector to take over a cargo from a external conveying mechanism.

Preferably, when the end effector is ready for receiving the cargo, the front end of the transport portion is arranged downstream of the external conveying mechanism in a transport direction, resulting in the front end of the end effector adjacent to the exit of the external conveying mechanism, and the upper surface of the transport portion is lower than that of the external conveying mechanism.

Preferably, each rolling portion comprises: a rotating shaft, of which two opposite ends are connected with the track frame, and a rolling cylinder sleeved on the rotating shaft or a rolling wheel sleeved on the rotating shaft.

Preferably, the end effector further includes a motor driving device that drives all or part of the rolling portions to rotate.

Preferably, at least one rib is connected between the outer frames of the track frame.

Preferably, the end effector further includes: a backplane mounted at one end of the transport portion, and the track frame connected with the backplane; and at least one suction cup mounted at the backplane, facing the direction in which the cargo comes in.

Preferably, the at least one suction cup comprises one or more of the following: an electrostatic suction cup, a vacuum suction cup, an electromagnetic suction cup.

In accordance with yet another aspect of the invention, a robot, comprising: an end effector as claimed above, and the end effector connected with the robot via an end connection portion.

The invention provides a conveyor mechanism with a suction cup, an end effector and a robot, and the conveyor mechanism can receive the cargo transported from a external conveying mechanism, and the suction cup can suck the cargo, so that the cargo is firmly placed on the conveyor mechanism to prevent it from falling, which increases the reliability of the robot to grasp the cargo, and also increases the upper limit of the moving speed of the robot arm while ensuring that the cargo does not fall down from the end effector, and meanwhile increases the success rate and processing speed of the logistics transportation.

### BRIEF DESCRIPTION OF THE DRAWINGS

FIG. 1 is a structure diagram of the conveyor mechanism with a suction cup according to the first embodiment of the present invention;

FIG. 2 is an application scenario and a structure diagram of the end effector and the robot to receive cargo;

FIG. 3 is an another view of the structure diagram of the end effector and the robot to receive cargo of FIG. 2.

### DETAILED DESCRIPTION OF THE INVENTION

In order to make the purpose, technical solutions and advantages of the implementations of the present invention much clearer, the technical solution of the present invention will be described in more detail below with reference to the accompanying drawings.

It should be noted that in the drawings, the same or similar reference numerals are used to refer to the same or similar elements or elements having the same or similar functions. The described embodiments are part of the embodiments of the invention and not all of the embodiments. In the case of no conflict, the embodiments of the present invention and the features in the embodiments may be combined with each other. It will be apparent to those skilled in the art that other embodiments may be obtained in accordance with the structures illustrated in the embodiments of the invention without departing from the scope of the invention. In the description of the present invention, it is to be understood that the terms “center”, “longitudinal”, “lateral”, “front”, “back”, “left”, “right”, “vertical”, “horizontal”, “top”, “bottom”, “inside” and “outside” and so on are indicating position or positional relationship based on the orientation or relationship shown in the drawing, which are only for the convenience of describing the invention and simplifying the description, rather than indicating or implying that the device or component must have a specific orientation, be constructed and operated in a specific orientation, so they cannot be understood as restrictions on the protection scope of the invention.

In this paper, “first”, “second”, etc. are only used to distinguish each other, not to indicate their importance and order, etc.

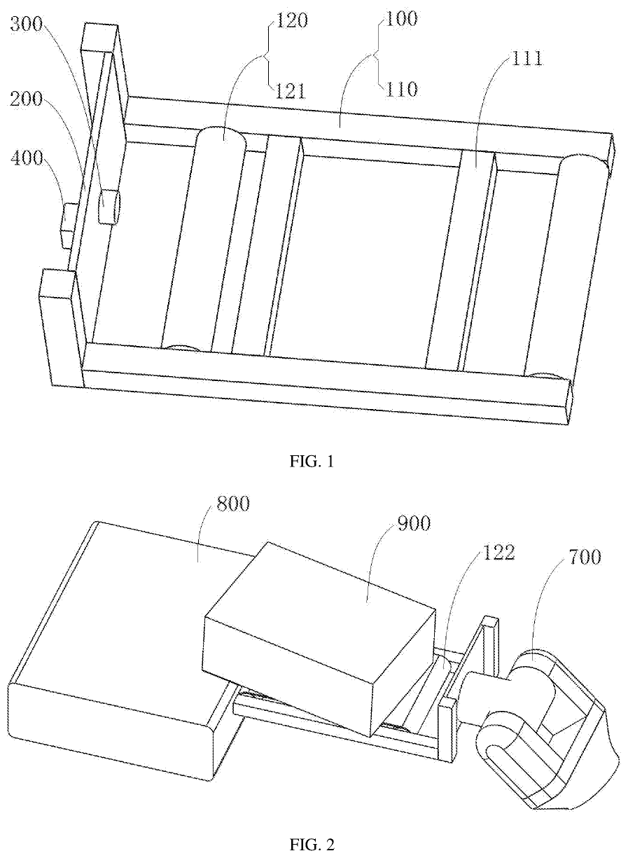

Referring to FIG. 1, a first embodiment of a conveyor mechanism with a suction cup provided by the present invention will be described in detail below. This embodiment is mainly applied to transport cargoes, for example, in the logistics and transportation scenarios such as handling passenger luggage at the airport, and the conveyor mechanism can receive the cargo transported from a external conveying mechanism, and the suction cup can suck the cargo, so that the cargo is firmly placed on the conveyor mechanism to prevent it from falling.

In the first embodiment, the conveyor mechanism includes a transport portion100, a backplane200 and at least one suction cup300. The transport portion100 is configured to receive the cargo900. The entrance of the transport portion100 is adjacent to the exit of the external conveying mechanism800, that is, the entrance of the transport portion100 arranged downstream of the external conveying mechanism800 in a transport direction for taking-over the cargo900 from the external conveying mechanism800, and when the cargo900 is transported from the external conveying mechanism800, the transport portion100 cooperates with the external conveying mechanism800 so as to receive the cargo900 from the external conveying mechanism800 into the transport portion100.

The backplane200 is mounted at one end of the transport portion100. The backplane200 is configured to be the rear end of the transport portion100 and be generally arranged perpendicular to the transport portion100 for blocking the cargo900 continuing transportation on the transport portion100 so as to handle subsequent step of the cargo900. When the cargo900 is transported to the backplane200, the cargo900 has been already partially or wholly into the transport portion100.

The suction cup300 is mounted at the backplane200, facing the direction in which the cargo900 comes in. The suction surface of suction cup300 is relative to the direction in which the cargo900 comes in, and when the cargo900 is transported to the backplane200 on the transport portion100, the suction cup300 adsorbs one side of the cargo900, which makes the cargo900 firmly and securely placed into the transport portion100 via the suction force of the suction cup300, preventing the cargo900 from falling off the conveyor mechanism.

It can be understood that the suction cup300 is arranged at the extremity of the transport portion100, so that the conveyor mechanism can only suck one cargo at a time, and the conveyor mechanism only receives one cargo at a time. As a result, the length of the transport portion100 is set based on the size of the cargo900, and when the cargo900 is attracted by the suction cup300, a part of the cargo900 may be exposed from the entrance of the transport portion100, which may avoid the situation that if the transport portion100 is a non-powered track, the transport portion100 can not drive the cargo900 continually to move on the transport portion100 to be attracted by the suction cup300 after the moment that the cargo900 is detached from the external conveying mechanism800 and the cargo900 has not touched the suction cup300.

Additionally, the transport portion100 comprises a track frame110 and a plurality of rolling portions120. The track frame110 is connected with the backplane200, and the plurality of rolling portions120 are arranged on the track frame110. The rolling portions120 are generally arranged parallel to the backplane200. After the front end of the cargo900 is delivered into the entrance of the conveyor mechanism from the external conveying mechanism800, the cargo900 is driven forward by the friction provided by the external conveying mechanism800. More specific, the transport portion100 can be with motive power or without motive power, and the rolling portions120 of the transport portion100 with motive power will rotate along with the external conveying mechanism800, and the cargo900 will move from the external conveying mechanism800 into the conveyor mechanism via friction; the transport portion100 without motive power does not exert any force onto the cargo900, such as pulling force, friction, etc., which helps the cargo900 to continue to be transmitted, and it only relies on the friction of the external conveying mechanism800 to drive the cargo900 to move forward and while the cargo900 is transporting on the transport portion100, the rolling portions120 can reduce the friction of the transport portion100 that hinders the movement of the cargo900.

In some embodiments, each rolling portion comprises a rotating shaft, of which two opposite ends are connected with the track frame110, and a rolling cylinder121 sleeved on the rotating shaft or a rolling wheel sleeved on the rotating shaft.

The number of the rolling portions120 is set according to both the length of the transport portion100 and the length of the cargo900, ensuring that the goods are carried by at least two rolling portions120 whenever they are on the transport portion100. More specific, every two rolling portions120 of the plurality of the rolling portions120 can be arranged closely adjacent to each other, that is, the number of the rolling portions120 is slightly smaller than the quotient of the length of the transport track and the diameter of the rolling portion, considering that there is a gap between every two rolling portions120. The rolling portion120 may be composed of one whole rolling cylinder121 sleeved on the rotating shaft, and the axial length of the rolling cylinder121 is slightly shorter than the width of the track frame110; or the rolling portion120 may be composed of a plurality of rolling wheels sleeved on the rotating shaft at particular intervals. If the transport portion100 is equipped with a power mechanism, the rotating shaft will rotate along with the external conveying mechanism800 to drive the rolling cylinder121 or the rolling wheels to rotate so as to drive the cargo900 on the transport portion100 to move forward by friction. If the transport portion100 is without a power mechanism, both the rolling cylinder121 and the rolling wheel can carry and deliver the cargo900 without power and meanwhile minimize the friction of the transport portion100 that hinders the movement of the cargo900.

In some embodiments, the transport portion100 further includes a conveyor belt122 that is sleeved over at least two rolling portions120 of the plurality of the rolling portions120. When the cargo900 is transported on the transport portion100, it can be directly driven to move by the rolling cylinder121 or the rolling wheel, alternatively it can be driven to move by the conveyor belt122. The number of the conveyor belt122 is set based on the number of the rolling portions120, and if each rolling portion is adjacent to each other, the conveyor belt122 may be sleeved on the outside of all the rolling portions120; alternatively the plurality of the rolling portions120 can be divided into a plurality of groups, and one conveyor belt122 is correspondingly sleeved on each group of the rolling portions120; alternatively the conveyor belt122 may be sleeved only on the part of rolling portions120 that is near the entrance of transport portion100. If the rolling portions120 are arranged in a scattered manner, that is, the plurality of rolling portions120 are far apart, the conveyor belt122 is generally sleeved on all the rolling portions120.

If the transport portion100 is equipped with the power mechanism, the sliding between the rolling portions120 and the conveyor belt122 can be prevented by a manner of meshing contact.

In some embodiments, the conveyor mechanism further includes a motor driving device that is driven all or part of the rolling portions120 to move. More specific, the motor driving device is coupled to the rotating shaft, and the motor driving device drives the rotating shaft to rotate so as to rotate the rolling portions120, and the conveyor belt122 is driven to move over the stationary rolling portions120. When the motor driving device is running, the motor driving device drives part or all of the rolling portions120 to run at the same linear speed as the external conveying mechanism800, which may avoid the situation that the cargo900 cannot be delivered to the destination because of something unexpected.

In some embodiments, the transport portion100 further comprises at least one rib111 which is connected between the outer frames of the track frame110. The rib111 is configured to strengthen the structure of the transport portion100 so as to increase the maximum loading weight of the conveyor mechanism. The transport portion100 may include a plurality of the ribs111 arranged among the plurality of the rolling portions120.

In some embodiments, the suction cup300 of the backplane200 comprises one or more of the following: an electrostatic suction cup, a vacuum suction cup, an electromagnetic suction cup. Electrodes on the surface of the electrostatic suction cup can generate and maintain a strong attracting force onto almost any object, and can attract a variety of objects such as cans, boxes, containers, glass plates, silicone boards and fiber boards. The vacuum suction cup made of rubber can be operated at high temperatures, and is ideal for gripping cargo with rough surfaces. Because of electromagnetic principle, a magnetic force is generated after the electricity power is turn on so that the electromagnetic suction cup can attract the workpiece; and after the electricity power is turn off, the electromagnetic suction cup can release the workpiece. The backplane200 may be equipped with one or more of the above three types of suction cups, for example, a vacuum suction cup and an electromagnetic suction cup are combined together for obtaining the cargo900.

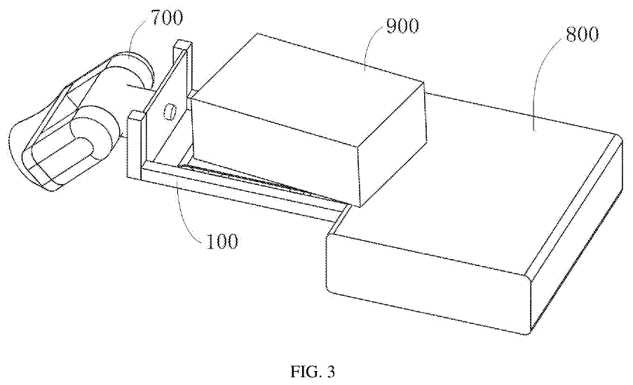

Referring to FIGS. 2 and 3 at the same time, it is the second embodiment that describes an end effector in detail provided by this invention.

Practically, this embodiment is mainly applied to transport cargoes, for example, in the logistics and transportation scenarios such as handling passenger luggage at the airport, and the end effector can receive the cargo900 conveyed from a external conveying mechanism800, and the suction cup300 can suck the cargo900, so that the cargo900 is firmly placed on the end effector to prevent it from falling, and meanwhile increasing the reliability of the end effector grabbing cargoes and cargoes processing speed.

The end effector of the second embodiment includes the conveyor mechanism provided by the first embodiment, and an end connection portion400. The conveyor mechanism includes a transport portion100, a backplane200 and at least one suction cup300. The transport portion100 is configured to receive the cargo900. The backplane200 is mounted at one end of the transport portion100 and is configured to be the rear end of the transport portion100. The suction cup300 is mounted at the backplane200, facing the direction in which the cargo900 comes in and the suction surface of suction cup300 is relative to the direction in which the cargo900 comes in. The end connection portion400 is arranged in the conveyor mechanism, and the end effector is configured to connect with a robot via the end connection portion400 so that a robot arm700 is coupled to the conveyor mechanism via the end connection portion400.

When the end effector is ready for receiving the cargo900, the front end of the end effector is arranged downstream of the external conveying mechanism800 in a transport direction for taking-over the cargo900 from the external conveying mechanism800, resulting in the front end of the end effector adjacent to the exit of the external conveying mechanism800, and the upper surface of the end effector is slightly lower than that of the external conveying mechanism800; alternatively the upper surface of the end effector is at the same height as that of the external conveying mechanism800. When the cargo900 is conveyed form the external conveying mechanism800, the motor driving device drives the conveyor belt122 of the transport portion100 to run so as the end effector to attract the cargo900 into the upper surface of the end effector from the external conveying mechanism800 and at last the cargo900 is conveyed to a position near the backplane200, and the robot controls the suction cup300 to suck the cargo900, resulting in finishing the receiving process of the cargo900. After that, the robot arm700 delivers the cargo900 to a destination, such as on a sorting line or in storage container.

Because of the cargo900 subjected to suction force of the suction cup300, during the end effector moving the cargo900, in addition to relying on the gravity of the cargo900 itself and the friction between the cargo900 and the conveyor portion to prevent the cargo900 from falling off the end effector, the suction force of the suction cup300 further stabilizes the placement of the cargo900, increasing the reliability of the end effector grabbing cargoes900.

The specific structure and the connection of the components such as the transport portion100, the backplane200, and the suction cup300 of the second embodiment can be set by referring to the structure and the connection described in the first embodiment above, and they will not be described again.

Referring to FIGS. 2 and 3 at the same time, it is the third embodiment that describes a robot in detail provided by this invention.

Practically, this embodiment is mainly applied to transport cargoes, for example, in the logistics and transportation scenarios such as handling passenger luggage at the airport, and the robot can receive the cargo900 transported from a external conveying mechanism800, and the suction cup300 can suck the cargo900, so that the cargo900 is firmly placed on the end effector to prevent it from falling, and meanwhile increasing the the reliability of the end effector grabbing cargoes and cargo processing speed.

A robot of the third embodiment includes the end effector provided by the second embodiment, and the end effector includes the conveyor mechanism provided by the first embodiment, and an end connection portion400. The conveyor mechanism includes a transport portion100, a backplane200 and at least one suction cup300. The transport portion100 is configured to receive the cargo900. The backplane200 is mounted at one end of the transport portion100 and is configured to be the rear end of the transport portion100. The suction cup300 is mounted at the backplane200, facing the direction in which the cargo900 comes in and the suction surface of suction cup300 is relative to the direction in which the cargo900 comes in. The end connection portion400 is arranged in the conveyor mechanism, and the end effector is connected with the robot via the end connection portion400 so that a robot arm700 is coupled to the conveyor mechanism via the end connection portion400.

When the robot is ready for receiving the cargo900, the front end of the end effector is arranged downstream of the external conveying mechanism800 in a transport direction for taking-over the cargo900 from the external conveying mechanism800, resulting in the front end of the end effector adjacent to the exit of the external conveying mechanism800, and the upper surface of the end effector is slightly lower than that of the external conveying mechanism800; alternatively the upper surface of the end effector is at the same height as that of the external conveying mechanism800. When the cargo900 is conveyed form the external conveying mechanism800, the motor driving device drives the conveyor belt122 of the transport portion100 to run so as the end effector to attract the cargo900 into the upper surface of the end effector from the external conveying mechanism800 and at last the cargo900 is conveyed to a position near the backplane200, and the robot controls the suction cup300 to suck the cargo900, resulting in finishing the receiving process of the cargo900. After that, the robot arm700 delivers the cargo900 to a destination, such as on a sorting line or in storage container.

Because of the cargo900 subjected to suction force of the suction cup300, during the end effector moving the cargo, in addition to relying on the gravity of the cargo itself and the friction between the cargo and the conveyor portion to prevent the cargo from falling off the end effector, the suction force of the suction cup300 further stabilizes the placement of the cargo, increasing the reliability of the end effector grabbing cargo and meanwhile increasing the upper limit of the moving speed of the robot arm while ensuring that the cargo does not fall down from the end effector.

The specific structure and the connection of the components such as the transport portion100, the backplane200, and the suction cup300 of the third embodiment can be set by referring to the structure and the connection described in the first embodiment above, and the specific structure and the connection of the components of the end effector of the third embodiment can be set by referring to the structure and the connection described in the second embodiment above, and they will not be described again.

The invention is described with reference to the accompanying drawings and the specifications. These and/or other aspects and advantages of the invention will become apparent and more readily appreciated from the following description of the embodiments, taken in conjunction with the accompanying drawings. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A conveyor mechanism equipped with a suction cup, comprising:
A transport portion(100), for receiving cargo;
A backplane(200) mounted at one end of the transport portion(100);
At least one suction cup(300) mounted at the backplane(200), facing the direction in which the cargo comes in.

2. The conveyor mechanism as defined in claim 1, wherein the transport portion comprises:
a track frame(110) connected with the backplane(200), and a plurality of rolling portions(120) arranged on the track frame(110).

3. The conveyor mechanism as defined in claim 2, wherein each rolling portion(120) comprises: a rotating shaft, of which two opposite ends are connected with the track frame(110), and a rolling cylinder(121) sleeved on the rotating shaft or a rolling wheel sleeved on the rotating shaft.

4. The conveyor mechanism as defined in claim 2, wherein the transport portion(100) further includes a conveyor belt (122) sleeved on at least two rolling portions(120) of the plurality of rolling portions(120).

5. The conveyor mechanism as defined in claim 2, wherein the conveyor mechanism further includes a motor driving device that drives all or part of the rolling portions(120) to rotate.

6. The conveyor mechanism as defined in claim 2, wherein at least one rib (111) is connected between the outer frames of the track frame (110).

7. The conveyor mechanism as defined in claim 1, wherein the at least one suction cup(300) comprises one or more of the following: an electrostatic suction cup, a vacuum suction cup, an electromagnetic suction cup.

8. An end effector, comprising: a transport portion(100), for receiving cargo;
and the transport portion including: a track frame(110), and a plurality of rolling portions(120) arranged on the track frame(110);
and the transport portion(100) having a conveyor belt(122) that is driven to move over the stationary rolling portions(120) so as the end effector to take over a cargo from a external conveying mechanism.

9. The end effector as defined in claim 8, wherein when the end effector is ready for receiving the cargo, the front end of the transport portion(100) is arranged downstream of the external conveying mechanism in a transport direction, resulting in the front end of the end effector adjacent to the exit of the external conveying mechanism, and the upper surface of the transport portion is lower than that of the external conveying mechanism.

10. A robot, comprising: an end effector as claimed in claim 8, and the end effector connected with the robot via an end connection portion.

11. The end effector as defined in claim 8, wherein each rolling portion(120) comprises: a rotating shaft, of which two opposite ends are connected with the track frame(110), and a rolling cylinder(121) sleeved on the rotating shaft or a rolling wheel sleeved on the rotating shaft.

12. The end effector as defined in claim 8, wherein the end effector further includes a motor driving device that drives all or part of the rolling portions(120) to rotate.

13. The end effector as defined in claim 8, wherein at least one rib (111) is connected between the outer frames of the track frame (110).

14. The end effector as defined in claim 8, wherein the end effector further includes: a backplane(200) mounted at one end of the transport portion(100), and the track frame(110) connected with the backplane(200); and at least one suction cup(300) mounted at the backplane(200), facing the direction in which the cargo comes in.

15. The end effector as defined in claim 14, wherein the at least one suction cup(300) comprises one or more of the following: an electrostatic suction cup, a vacuum suction cup, an electromagnetic suction cup.
